(19) United States
(12) Patent Application Publication
(10) Pub. No.: US 2003/0178969 A1
(43) Pub. Date: Sep. 25, 2003

(54) UPS device combining charging for mobile phones and emergent illumination

(76) Inventor: Frank Chang, Sanchung City (TW)

Correspondence Address: David E. Dougherty, 612 Crystal Square 4, 1745 Jefferson Davis Highway, Arlington, VA, 22202-3417, US

(21) Appl. No.: 10/212,712

(22) Filed: Aug. 7, 2002

(30) Foreign Application Priority Data
Mar. 25, 2002 (TW) 91203648

(51) Int. Cl. H02J 7/00

(52) U.S. Cl. 320/112

(57) ABSTRACT

A UPS device combining charging for mobile phones and emergent illumination enhances a UPS to support emergent illumination when power blackout occurs and charging for mobile phones. The invention utilizes a UPS to detect interruption of power input to activate emergent illumination devices as well as adjust the power conversion to deliver a 12V DC output to charge mobile phones or batteries to support mobile phones for communication.

### FIELD OF INVENTION

The present invention relates generally to a UPS device combining charging for mobile phones and emergent illumination, and more particularly to a device that utilizes a UPS to detect interrupt of power input to activate emergent illumination devices as well as adjust the power conversion to deliver a 12V DC output to charge mobile phones or batteries to support mobile phones for communication.

### BACKGROUND OF INVENTION

Mobile phones have become a necessary communication tool in today's world. Because the mobile phones utilize batteries as their power supply unit, chargers are indispensable to charge the batteries when the power of them is consumed. Only by this way can the mobile phones be used continuously. For people in country or in open field, in case that power blackout occurs at the region, the fixed phone will not be available, and the portable phone may be the only communication tool to seek for help at that time. However, due to limited standby duration and conversation duration supported by mobile phones, two-way communication with the outer world will be ceased under the circumstance that the power of the batteries is exhausted and has no access to be recharged.

Emergent illumination devices are designed to provide temporary illumination at power blackout with the batteries recharged previously. Typically, most emergent illumination devices are mounted at certain fixed locations. Though ideally those devices should be checked and maintained routinely to keep them effective, scenarios that fixed emergent illumination devices can't deliver satisfactory illumination at emergences occur frequently.

Furthermore, most UPS devices are equipped along with computers or precision instruments to provide a buffering time period at power blackout to shut off those devices or take necessary measures, the purpose of which is to avoid information loss or hardware failure. Because that those computers or precision instruments are used frequently, the routine inspection, maintenance, and reparation for UPS devices become a hard task.

Please refer to FIG. 3, a traditional UPS device usually comprises:

a voltage regulating unit 1 regulating the electric supply and eliminate electric surge in order to ensure the output voltage is not effected by the fluctuant input electric supply;

a charging unit 2 charging the battery 2A with the electric power source in order to ensure sufficient power when power blackout occurs;

a electric supply detecting unit 3 monitoring the electric supply in order to detect interruption of power input caused by low voltage;

a voltage inverting unit 4 transforming DC current from the battery into AC current when power blackout occurs;

a switching unit 5 switching to use the power of the battery 2A which is converted by the voltage inverting unit 4 when the electric supply is interrupted, while the normal output supply is provided by the voltage regulating unit 1 with the stabilized electric supply;

a battery monitoring unit 6 shutting off the power to the power inverting unit 4 in case that the battery 2A is low in electric capacity or the permissible load is exceeded in order to ensure the safety of the UPS; and

a power supply unit 7 delivering power to electronic components of the UPS with the battery 2A in order to ensure the normal operation of UPS both in normal electric supply or power blackout cases and the low consumption of electric power by the UPS.

The traditional UPS device described above has a shortcoming to be solved, i.e., because the power supply unit 7 of the UPS consumes the power of the battery all the time, the entire UPS will halt in case the battery is low of power. In a traditional UPS, the switch for the main power is manually controlled, and the UPS will enter battery 2A supply mode when the electric supply is interrupted if the switch is on. However, if the user takes a long vacation or holiday (e.g., annual leave, spring festival holiday, or go abroad) or the electric supply in that region is not available for a long time and he/she forgets shutting off the UPS, the device will continuously serve until it is switched off by the battery monitoring unit 6 when the battery is low of power. Even in that situation, the power supply unit 7 continues consuming the power of battery until the battery dries in about 8 hours. Then the UPS will halt due to its control units are short of power, and the charging unit 2 can't charge the battery 2A even though the electric power resumes. And the UPS will continue to work until the battery 2A is changed.

### SUMMARY OF INVENTION

In consideration of the shortcoming in traditional UPS devices, the inventor puts forth a new UPS device, which not only eliminates that shortcoming but also enhances the efficacy of traditional UPS devices.

The major object of the invention is to provide a UPS combining charging for mobile phones and emergent illumination, that is to say, the device utilizes a UPS to detect interruption of power input to activate emergent illumination devices as well as adjust the power conversion to deliver a 12V DC output to charge mobile phones or batteries to support mobile phones for communication.

Another object of this invention is to provide a UPS combining charging for mobile phones and emergent illumination, which is capable of detecting the electric quantity in its battery and the invalidation of the battery.

### BRIEF DESCRIPTION OF DRAWINGS

The technical approach and efficacy of this invention are further described in the following embodiments and illustrations, by which the object, the constitution and the characteristic of the invention can be illuminated soundly and concretely, wherein:

FIG. 1 is a block diagram of a preferred embodiment that is implemented according to this invention;

FIG. 2 is a block diagram of another embodiment that is implemented according to this invention; and

FIG. 3 is a block diagram of the control circuit of a traditional UPS device.

### DETAILED DESCRIPTIONS OF EMBODIMENTS

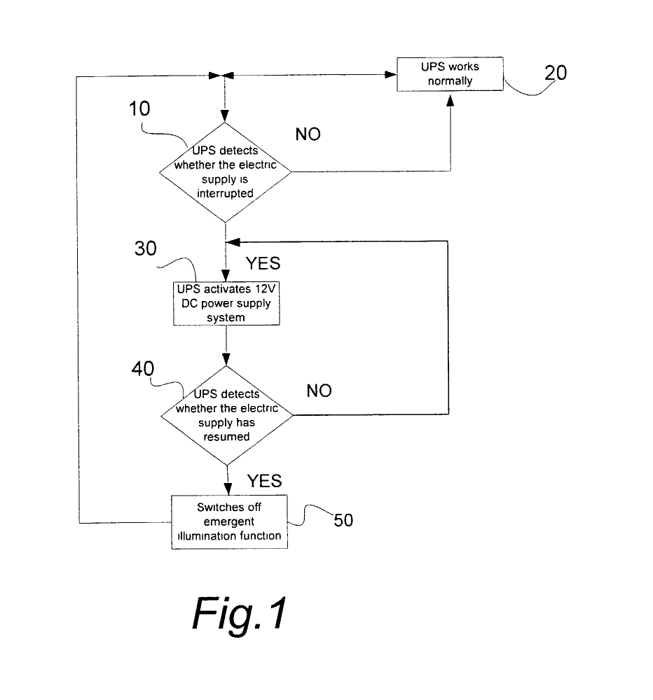

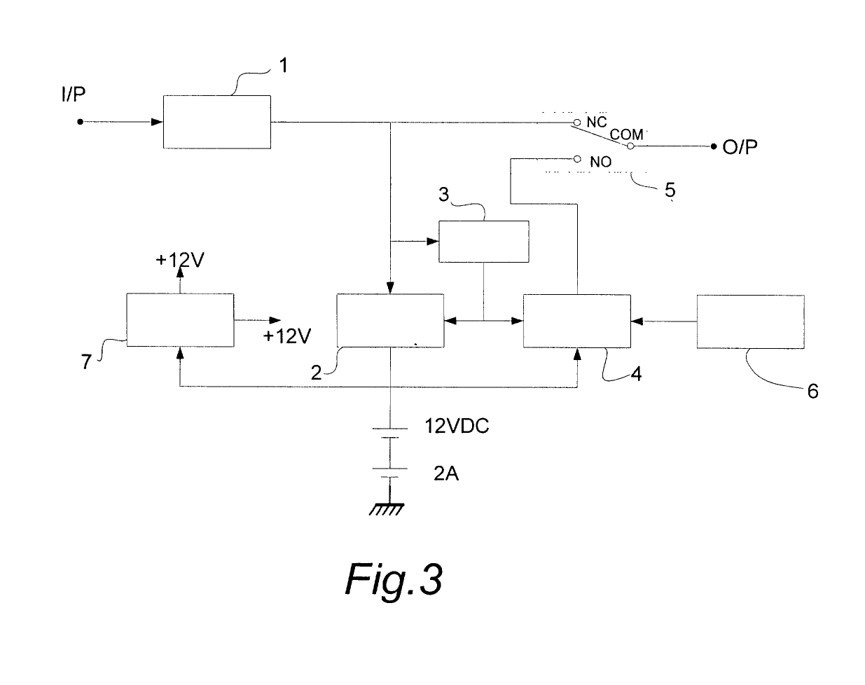

Please refer to FIG. 3. The UPS device implemented in accordance with this invention also comprises a voltage-regulating unit 1, a charging unit 2, a battery 2A, a electric supply monitoring unit 3, a power inverting unit 4, a switching unit 5, a battery monitoring unit 6, and a power supply unit 7. Please see FIG. 1, the emergent illumination functionality of the UPS implemented in accordance with this invention is to activate emergent illumination devices when the UPS detects the electric supply is interrupted. That is to say, the UPS monitors whether the electric supply is interrupted 10, and it activates the 12V DC battery supply circuit 30 if the electric supply is interrupted (Yes); otherwise (No) the UPS operates in normal state 20. In the battery supply mode, the UPS monitors whether the electric supply resumes 40, and it switches off the emergent illumination circuit 50 and returns to the status of normal operation 10 if the result is true (Yes); otherwise (No) it stays in the 12V DC battery supply mode 30.

The emergent illumination function of above UPS can be automatically controlled, or is switched off at status of normal operation to reduce the power loss at the battery. Furthermore, the battery can be recharged continuously, or can be recharged when the electric supply resumes. And the electric quantity of the battery can be controlled automatically.

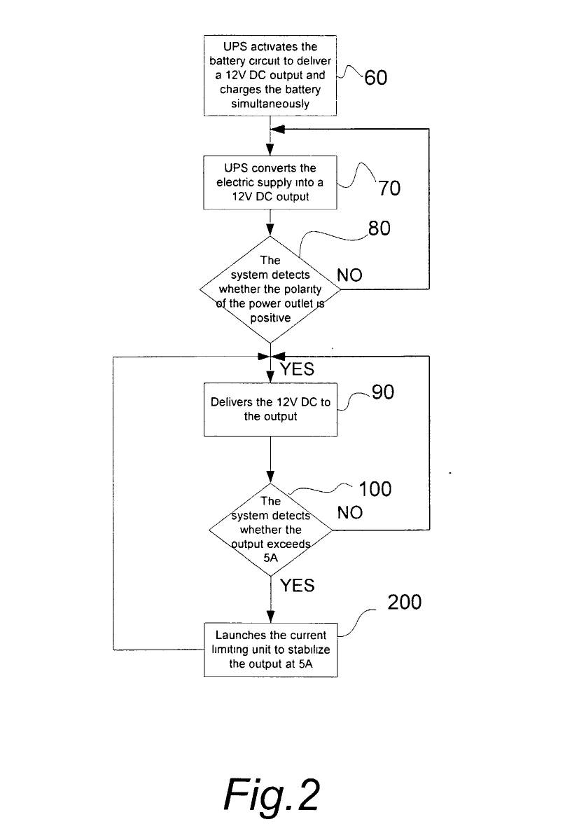

Please refer to FIG. 2, a mobile phone emergency charger, which utilizes the UPS to adjust the power conversion to deliver a 12V DC output to charge mobile phones or batteries to support mobile phones for communication. The UPS delivers a 12V DC output from the battery and charges the battery 60 at same time. It also converts the AC electric supply to 12V DC output 70. The UPS detects whether the polarity of the outlet is positive 80, if the result is “not” (No), it continues converting the AC electric supply to 12V DC output; otherwise (Yes) it will activate the battery supply circuit to deliver a 12V DC to the socket 90 and detects whether the output current exceeds 5A 100. If the current doesn't exceed 5A (No), it will continue delivering a 12V DC (provided by the battery) to socket 90; otherwise (Yes) it will activate the current limiting device to stabilize the output at 5A 200, and revert to activate the battery supply circuit to deliver a 12V DC to the socket 90.

The above device will serve whenever the electric supply is interrupted, and it can also be used in normal electric supply cases. Furthermore, it provides a current limiting function, which avoid any damage to batteries or mobile phones being recharged due to unstable power supply.

From above description we can be convinced that the technology disclosed in the embodiment implemented according to the UPS device combining charging for mobile phones and emergent illumination attains the anticipative purpose of promoting the development of production. Furthermore, the constitute of the embodiment has never been published or used publicly before the application. Therefore, the invention meets all requirements for a new patent, thus the inventor applies for a new patent with it.

What is claimed is:

1. A UPS device combining charging for mobile phones and emergent illumination, wherein the UPS would activate a 12V DC power supply to provide emergent illumination when the UPS detects the electric supply being interrupted as well as activate the battery circuit to deliver a 12V DC output to charge mobile phones; the UPS detects whether the polarity of the power outlet is positive to determine whether to provide the 12V DC output to the outlet; the UPS detects whether the output current exceeds 5A to determine whether to launch the current limiting unit to stabilize the output at 5A.

2. The UPS device combining charging for mobile phones and emergent illumination as defined in claim 1, wherein said emergent illumination function can be automatically controlled or be switched off in status of normal electric supply to minimize the power loss of the battery.

3. The UPS device combining charging for mobile phones and emergent illumination as defined in claim 1, wherein said UPS can be used both in power blackout circumstance and in status of normal electric supply.

4. The UPS device combining charging for mobile phones and emergent illumination as defined in claim 1, wherein the battery is renewable in order to be recharged and used when the electric supply resumes, and the quantity of electricity charged into the battery can be controlled automatically by the UPS.

5. The UPS device combining charging for mobile phones and emergent illumination as defined in claim 1, wherein the output current protection function can avoid any damage to mobile phones or batteries being charged when the power supply is unstable.
